(19) United States
(12) Patent Application Publication
(10) Pub. No.: US 2013/0091157 A1
(43) Pub. Date: Apr. 11, 2013

(54) FILE SERVER SEARCH AND RECOMMENDATION SYSTEM

(71) Applicants: Robin Budd, Seattle, WA (US); Manuel Vellon, Bellevue, WA (US); Gerald Carter, Dadeville, AL (US)

(72) Inventors: Robin Budd, Seattle, WA (US); Manuel Vellon, Bellevue, WA (US); Gerald Carter, Dadeville, AL (US)

(21) Appl. No.: 13/267,778

(22) Filed: Oct. 6, 2011

(51) Int. Cl. G06F 17/30

(52) U.S. Cl. 707/758; 707/E17.032; 707/E17.01

(57) ABSTRACT

Enhanced computer- and network-based methods, techniques, and systems for an enhanced file server that provides search and recommendations “in-band” as part of a request to the file server are provided. Example embodiments provide a Enhanced File Server (“EFS”), which enables file servers and the like, to search for and/or to recommend information (e.g., content, data, or the like) based upon a file request to the file server. This enables a user of the EFS to avoid the use of a separate search or recommendation system, such as a search engine, to find information. An Enhanced File Server implements its own search and recommendation capabilities and allows users to search for and obtain recommendations for information through its standard file-access mechanisms. Searches and requests for recommendations are performed using especially constructed file names The EFS may present results to the user using synthesized content.

### TECHNICAL FIELD

The present disclosure relates to methods, techniques, and systems for providing searches and/or recommendations and, in particular, to methods, techniques, and systems for providing search and/or recommendation capabilities from within a file server.

### BACKGROUND

Organizations frequently find it useful to share information between users. They often employ “content servers” such as file servers and Web servers to make this information accessible. Unstructured data (“files”) stored in traditional file servers, Web servers and other content servers constitute the largest percentage of data in many enterprises. According to some sources, this type of information is also the fastest growing category of data.

File servers may be general purpose computing systems running file-sharing services for example, Microsoft Windows Server, or dedicated devices such as those manufactured by NetApp. Web servers may also be general purpose computing systems for example, based on Apache Web Server or Microsoft IIS, or special-purpose computing systems such as the Wordpress blogging system or Microsoft Sharepoint. These servers allow users to create, modify and delete information of interest to multiple users. Over time, however, these servers frequently end up containing massive amounts of data making it difficult to find (e.g., determine, locate, etc.) information of interest.

Although traditional file servers and Web servers typically offer mechanisms for organizing data, for example, the use of directories and hyperlinks, it is increasingly difficult to find data of interest when the volume and growth of such information is large.

Content search tools, for example Google Enterprise Search or Microsoft Search, can scan files in content servers to create full-text indices that speed up content-based searches, for example, a search of all files that contain “employee birthdays,” but they don't identify whether the information found is up-to-date or in-use by other people in the company. File and Web servers are frequently full of old, out-of-date, information that is no longer accurate or relevant. Distinguishing between useful and useless data in content servers is a difficult problem.

To solve this problem, some systems, for example, media storage or shopping services, frequently offer “recommender” systems, sometimes just referred to as “recommenders,” to suggest data of interest to their users. These recommender systems are often based on the access patterns of other users deemed to be similar to the searching user. Similarity is sometimes based on common social group memberships (such as friends in social networking applications) or on similar activity patterns, such as buying patterns.

For example, when a user buys a particular product with an online vendor, for example Amazon, its recommender system may also suggest other products of interest to you. Or, for example, when a user creates a radio “station” on an online music provider (such as Pandora) to track a particular artist, it may play songs by the artist but also other songs deemed similar by its recommender system. These systems may use various algorithms to filter information.

Search tools and recommender systems typically implement their software by providing a Web-based or operating system “shell-based” user interface. A user of Microsoft Windows 7, for example, can search for files in a file server by opening up an operating system “Explorer” window and typing a search pattern in the “Search” field. As another example, users of Google Enterprise Search may deploy a search “appliance” that indexes the data in their file servers (and other locations) and presents a familiar Google type of Web interface to search through data. Other off-the-shelf search engines provide similar querying capabilities.

### BRIEF DESCRIPTION OF THE DRAWINGS

FIG. 1 is an example block diagram of an enhanced file server environment that implements an example search and recommender system according to example embodiments.

FIG. 2 is an example flow diagram illustrating logic for providing search and recommender capabilities using a file server.

FIG. 3 is an example block diagram of an example computing system that may be used to practice embodiments of a enhanced file server using an enhanced file pathname syntax.

### DETAILED DESCRIPTION

Embodiments described herein provide enhanced computer- and network-based methods, techniques, and systems for an enhanced file server that provides search and recommendations “in-band” as part of a request to the file server. The term “in-band” refers to use within the file server environment as opposed to “out-of-band” which refers to a system separate from the file server. Example embodiments provide a Enhanced File Server (“EFS”), which enables file servers and the like, to search for and/or to recommend information (e.g., content, data, or the like) based upon a file request to the file server. This enables a user of the EFS to avoid the use of a separate search or recommendation system, such as a search engine, such as Google, Bing, Yahoo, or Google Enterprise Search, to find information. In particular, an Enhanced File Server implements its own search and recommendation capabilities and allows users to search for and obtain recommendations for information through its standard file-access mechanisms. Searches and requests for recommendations are performed using especially constructed file names (hence the notion of “in-band”). Rather than forcing a user to view search and recommender results in separate areas, windows, and/or systems, the EFS may present results to the user using synthesized content.

For the purposes used herein, the term “user” or “requester” refers to the code requesting the file, search, and/or recommendation, for example, from the file server. It may mean the code used to implement the UI control in a browser, for example, or other code, that eventually translates to a request of the file server to provide a search or recommendation.

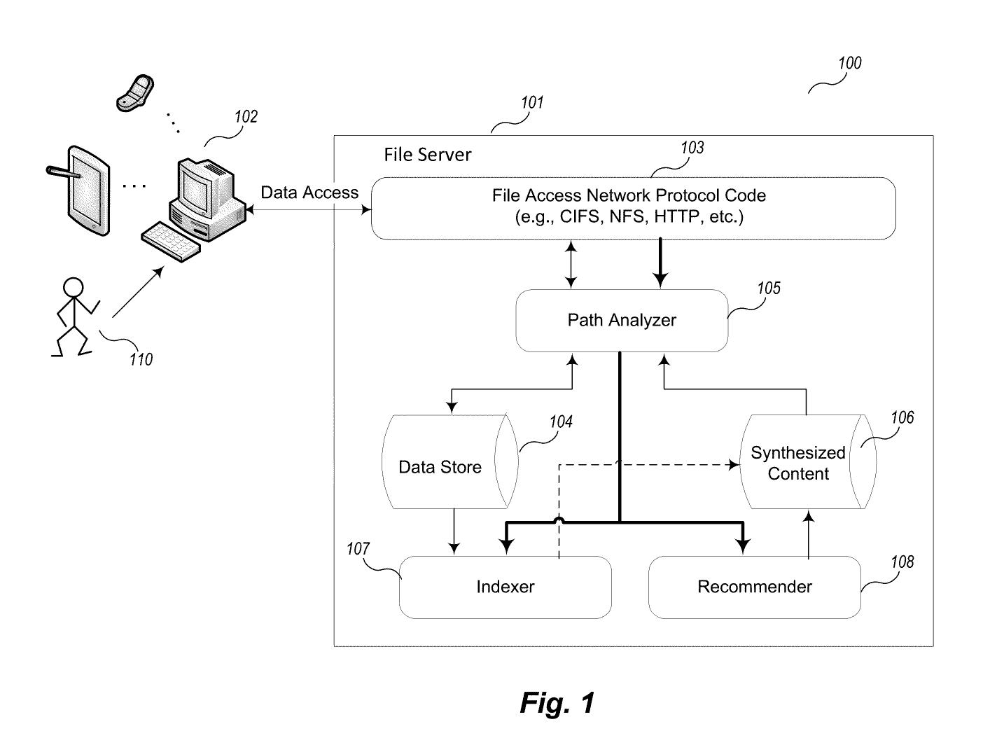

FIG. 1 is an example block diagram of an enhanced file server environment that implements an example search and recommender system according to example embodiments. File server environment 100 comprises an enhanced file server 101 and a requester computing system 102. In example embodiments, the enhanced file server 101 comprises one or more functional components/modules that work together to provide user requested searches and recommendations. Specifically, the enhanced file server 101 comprises file access network protocol code 103, one or more data repositories, such as data store 104 and a synthesized content store 106, a path analyzer 105, an indexer 107, and a recommender 108. In some example embodiments, the enhanced file server 101 is implemented in a distributed manner and one or more of these components is available externally and communicates via standard or proprietary interprocess communication protocols. For the purposes described herein, the enhanced file server 101 may be a file server such as a Windows or a Unix/Linux file server or any other type of enhanced file server that implements the enhanced file name protocol described herein.

In operation, a user 110 accesses (e.g., requests for access) one or more files from the enhanced file server 101 using a requester computing device 102 (requester) and requests data (e.g., files, searches, and/or recommendations) from the enhanced file server 101. This device may be a desktop computing system or notebook computer but it may be a server, a tablet, a cellular phone, or any other computing device that supports the necessary network protocols to communicate with the enhanced file server. The requester 102 may make requests on behalf of users and receive results, such as from a computing program, with or without direct user involvement from a human being.

The enhanced file server 101 receives and processes protocol messages from the requester 102 (regular weight lines between modules 103-108) and provides requested data by decoding and acting on these messages (heavily weight lines between modules 103, 105, 107, and 108). The messages are received via file access network protocol code 103. Without the enhancements for search and recommendation, a typical file server would simply receive a request for one or more files (e.g., data or information) through file access network protocol code 103 and return the requested data from data store 104. To provide information using the enhancements described herein, the file server 101 analyzes an information request and provides requested data using either the data store 104 or the synthesized content store 106.

The indexer 107 component (optional in some embodiments) analyzes the content in the data store 104 and creates an index of the data (not shown). These indices can be quickly searched to find patterns present in content without having to actually read the data. The indexer 107 may be used by an EFS and/or by other searching facilities to access data from the data store 104 without reading it.

The recommender 108 operates by integrating data from the indexer 107 and other sources (for example, file access history). If a user (through a computing device 102) has accessed a particular file, for example, the recommender 108 may look for other data that have similar contents (based on information from the indexer 107) that have been recently read by other users. For example, U.S. Provisional Patent Application No. 61/538,525, entitled “Recommender System for a Content Server Based on Security Group Membership,” filed on Sep. 23, 2011, incorporated herein by reference in its entirety, describes a mechanism for determining similarity based upon a degree of similarity between the user and other users in a security group to which the user belongs. Other algorithms for determining similarity may be incorporated and used by recommender 108 to provide data recommendations.

In overview of operation, the file server 101 determines which data to access by analyzing the incoming file paths (e.g., file pathnames, file specification, data specification, etc.) when a requester computing device 102 opens a file on the file server 101. The file server 101 reviews the incoming file specification and looks for special paths that indicate that the requester computing device 102 would like to search for data or would like the file server 101 to recommend data. If the file server 102 detects a special file pathname, the file server 102 forwards the information request specified by the file specification to the indexer 107 or to the recommender 108. These indexer 107 and/or recommender 108 perform their requested operations and then create synthesized content in synthesized content 106 which is returned to the requester computing device 102.

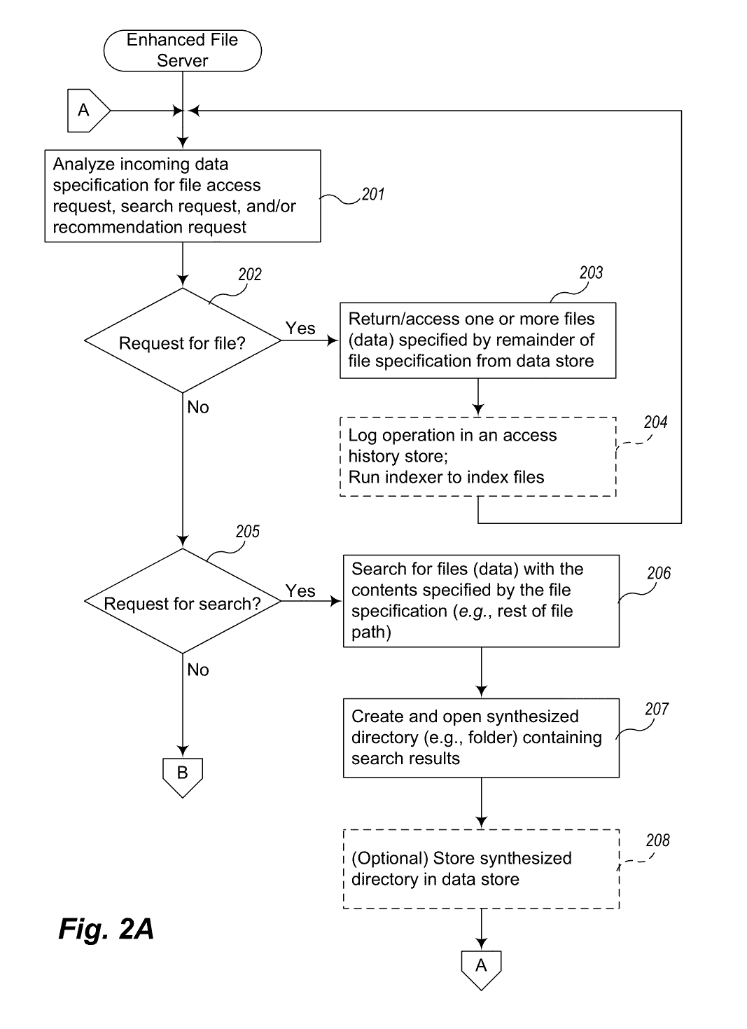

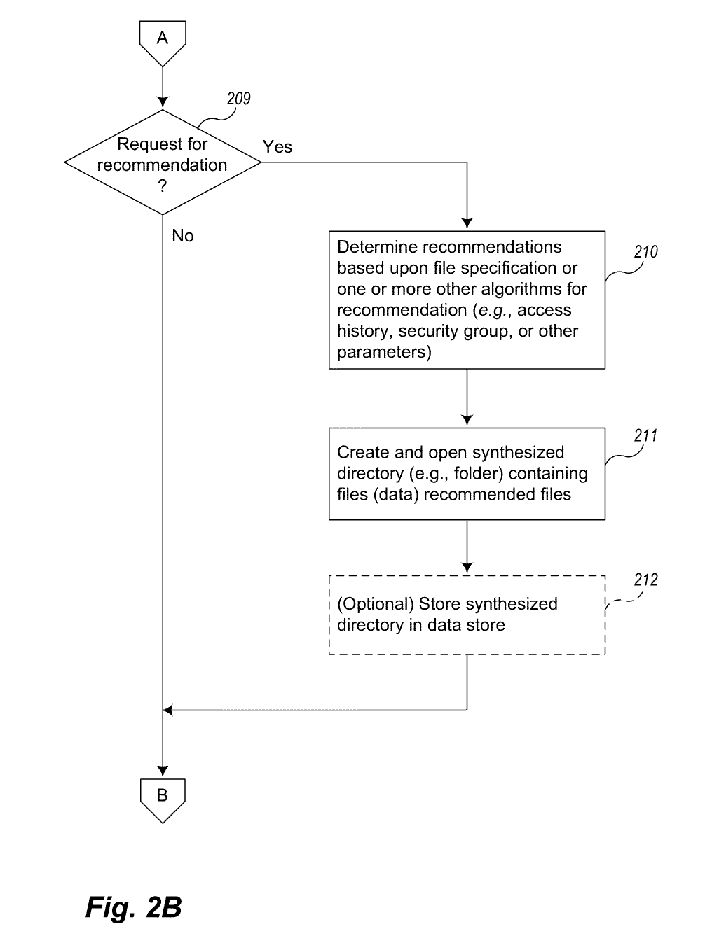

FIG. 2 is an example flow diagram illustrating logic for an enhanced file server operation to implement search and recommender capabilities. As described with respect to FIG. 1, the Enhanced File Server processes normal file access requests along with requests for a search and/or recommendation using enhanced file pathname mechanism.

Specifically, in block 201, the EFS analyzes the incoming data specification (e.g., file path, file pathname, file specification, or the like) to determine whether it has received a file access request, a search request, and/or a recommendation request (e.g., a “special” path). In some embodiments, this logic can be performed by path analyzer 103 in conjunction with the file access network protocol code 103 (e.g., CIFS, NFS, HTTP, etc.). The EFS, such as file server 102, implements requests for searches and recommendations using an enhanced file pathname mechanism. An enhanced or special file pathname contains sufficient information to both identify the type of request (for file access, search, or recommendation) and the specifics of the request.

Current operating systems typically provide some mechanism for accessing files in a shared file server. Microsoft Windows, for example, allows drive letters (“D:”, “E:”, etc.) to be mapped to file “shares” on shared file servers. Windows accesses data on these file servers by utilizing the “SMB” network protocol (also called the “CIFS” protocol). UNIX and Linux can access file servers by using SMB/CIFS but also access file servers using the NFS, FTP and WebDAV protocols. Although these protocols provide numerous functions and each protocol implements them in a unique fashion, all protocols provide a mechanism to open a particular file or directory on a server by identifying its “path” (identification of a location of a file). A file pathname is typically of the form:

<delimiter><name>[<delimiter><name>]*

Where <delimiter> is one or more designated characters used to separate the various <name> elements. The <name> elements are used to identify intermediate subdirectories ultimately leading to the directory (e.g., folder, container, etc.) containing the requested path.

For example, a valid file pathname in the Windows operating system may be expressed as:

\users\jsmith\documents\widget.pdf

This path indicates that the “widget.pdf” file can be found in the (sub)directory “documents” which is contained in the (sub)directory “jsmith”, which is contained in the directory “users”. The “users” directory is found at the “top” (root directory) of the directory hierarchy (in other words, in the “\” directory).

For example, a valid file pathname in the Unix/Linux operating system may be expressed as:

/home/jsmith/documents/widget.pdf

This path indicates that the “widget.pdf” file can be found in the (sub)directory “documents” which is contained in the (sub)directory “jsmith”, which is contained in the directory “home”. The “home” directory is found at the “top” (root directory) of the directory hierarchy (in other words, in the “/” directory).

Windows and UNIX/Linux support similar file pathnames with the exception of their use of different delimiter's. Other operating systems may provide a different file pathname syntax, however.

In order to implement search and/or recommendation requests, the EFS implements an enhanced path mechanism that extends these syntax conventions. In particular, specific to the operating system and in some cases the protocol, the EFS implements a convention for each type of file pathname syntax that allows the EFS to recognize a request for a search or for a recommendation.

For example, using the Windows syntax, a file pathname of the form:

\search\employee birthdays

may be used to indicate to the EFS that a request for a search for files with the contents specified by the rest of the file pathname (e.g., “employee birthdays”) is desired. Similarly, using the UNIX/Linux syntax, a file pathname of the form:

/search/employee birthdays

may be used.

Similarly, for requests for recommendations, the EFS may be programmed to recognize a pathname beginning with “recommendation” in the appropriate syntax. For example, using the Windows syntax, a file pathname of the form:

\recommendation

### Or

\recommendation\<file_name>

may be used to communicate to the EFS that a request fora recommendation (based upon a particular file name, <file_name>, in the second case) is desired.

Using the UNIX/Linux syntax, a file pathname of the form:

/recommendation

### Or

/recommendation/<file_name>

may be similarly used to request a recommendation. Of course, other file syntaxes may be accommodated, and other key terms can be replaced for “search” and for “recommendation” to achieve similar results.

In addition, to avoid limiting the ability to use the key terms as real file names or directories and to be able to enter characters that are considered invalid in a particular file pathname syntax, an “escape” character mechanism is used. The escape character mechanism allows such disallowed characters to be mapped into valid characters as necessary. For example, one example embodiment of the EFS uses a “$” character (a dollar sign character) as the escape character.

For example, while “\search\employee birthdays” could indicate a search request using Windows syntax, “\$search\employee birthdays” could indicate a request to open the file “employee birthdays” in the “\search” directory. Also, escape characters can be used to escape themselves, for example, “\$$search\employee birthdays” could be a request to open the “employee birthdays” file in the directory called “\$search”. A different escape character (for example “&”) can be used to handle illegal characters in the particular syntax. The following path demonstrates use of this technique:

/search/This is a backslash&co&bs this is a slash&co&sl

Here, &co indicates a colon (“:”), &bs indicates a backslash (“\”) and “&sl” indicates a forward slash (“/”). Again, repeated escape characters can be used when the escape character is to be taken literally (“&&” indicates “&”).

Once the EFS determines analyzes the file pathname, the logic procees to block 202. In block 202, if the EFS determines that the file pathname is a request for a file access (or doesn't contain a request for a search or for a recommendation), then the EFS proceeds to block 203, otherwise continues to block 205. In block 203, the EFS logic returns, or otherwise provides access to, the requested one or more files specified by the remainder of the file specification from the data store, for example data store 104 of FIG. 1. Optionally, in some embodiments, in block 204, the EFS logic logs the performed operation in an access history store (not shown), for example, to be used to provide recommendations by a recommendation system such as recommender 108, and then continues to the beginning of the loop to block 201 to process the next file server request.

In block 205, the EFS determines whether the file pathname is a request for a search and, if so, proceeds to block 206, otherwise continues to block 209). For example, if the EFS determines that the user has indicated the special key term “search” in the file pathname, then the EFS may conclude that a search is requested. In block 206, the EFS logic initiates a search for files (data) matching contents as specified by the remainder of the enhanced file pathname specification. This logic may be performed, by example, using the indexer 107 and/or the data store 104 of the EFS 101 in FIG. 1.

When matching results are found, then in block 207, the EFS creates search results, for example, by opening up a “synthesized” directory (folder) containing the files that match the search criteria. These synthesized results may be stored, for example, in the synthesized content store 106. For example, using the special path indicated above “\search\employee birthdays”, files that contain the phrase “employee birthdays” may be considered to match the request and therefore are stored in synthesized content. Different search matching algorithms may be accounted for included potentially intricate or involved syntax to indicate matching particular parts of files and/or data, etc. If no matching results are found, then different responses are possible, including for example, returning an empty synthesized directory or an error message.

In block 208, in some embodiments, the EFS optionally stores the synthesized directory in the normal file store, e.g., data store 104, so that it may be accessed again. The logic then continues to continues to the beginning of the loop to block 201 to process the next file server request.

In block 209, the EFS determines whether the file pathname is a request for a recommendation and, if so, proceeds to block 210, otherwise continues to block 201 to process the next file server request (or to continue with other processing). For example, if the EFS determines that the user has indicated the special key term “recommendation” in the file pathname, then the EFS may conclude that a recommendation is requested. In block 210, the EFS logic initiates a recommendation for files (data) based, in some embodiments, upon contents as specified by the remainder of the enhanced file pathname specification, based upon a prior access history, or based upon some other criteria (parameters, factors, and the like) as implemented by a recommender system. This logic may be performed, by example, using the recommender 108 of the EFS 101 in FIG. 1.

In block 210, the EFS logic determines relevant recommendations and then opens up (creates, makes available, etc.) a “synthesized” directory (folder) containing the files that are to be recommended. These synthesized results may be stored, for example, in the synthesized content store 106.

In block 212, in some embodiments, the EFS optionally stores the synthesized directory containing the recommendations in the normal file store, e.g., data store 104, so that it may be accessed again. The logic then continues to continues to the beginning of the loop to block 201 to process the next file server request.

In other embodiments, more, less, and or different logic may be implemented. In general, the Enhanced File Server provides one or more mechanisms, using its standard file pathname syntax to request searches and/or recommendations and to provide the results “in band” using standard shared file network protocols and synthesized content. In addition, the concepts and techniques described are applicable to any type of server of file server as long as the syntax for search and for recommendations is programmed into the file server.

Also, although certain terms are used primarily herein, other terms could be used interchangeably to yield equivalent embodiments and examples. For example, it is well-known that equivalent terms can be used interchangeably. In addition, terms may have alternate spellings which may or may not be explicitly mentioned, and all such variations of terms are intended to be included.

Example embodiments described herein provide applications, tools, data structures and other support to implement a Security Based Recommender to be used for providing content recommendations based upon security group information. Other embodiments of the described techniques may be used for other purposes. In the following description, numerous specific details are set forth, such as data formats and code sequences, etc., in order to provide a thorough understanding of the described techniques. The embodiments described also can be practiced without some of the specific details described herein, or with other specific details, such as changes with respect to the ordering of the code flow, different code flows, etc. Thus, the scope of the techniques and/or functions described are not limited by the particular order, selection, or decomposition of steps described with reference to any particular routine.

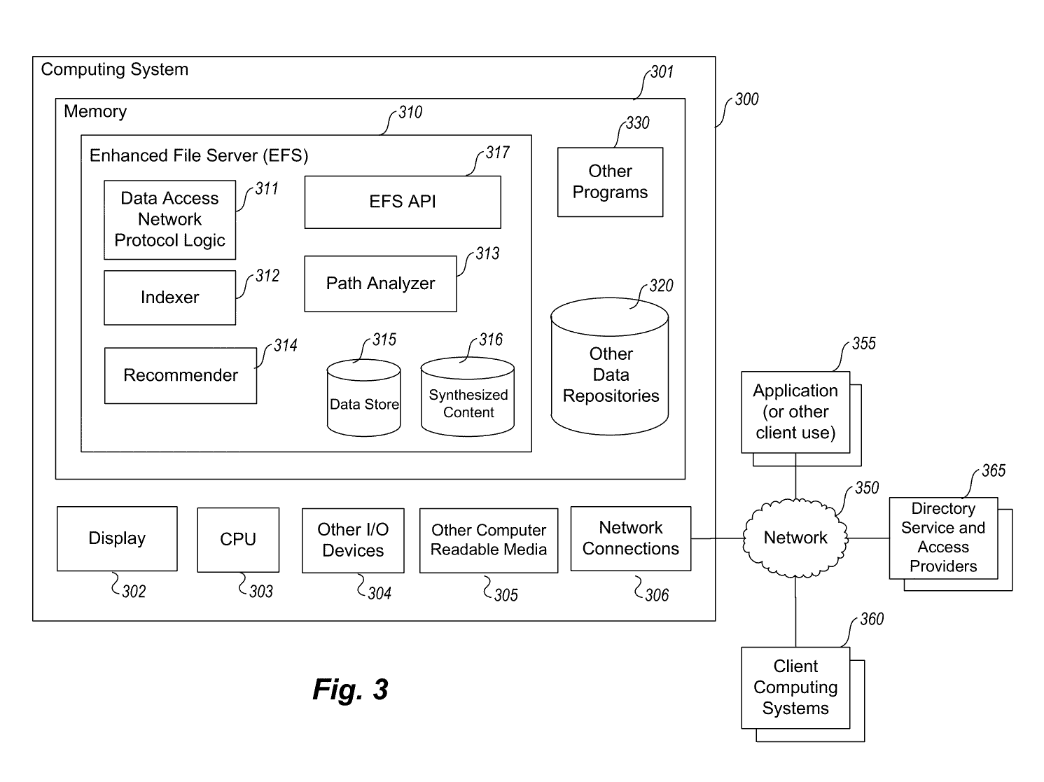

An exemplary enhanced file server may be implemented by a general purpose or a special purpose computing system suitably instructed. FIG. 3 is an example block diagram of an example computing system that may be used to practice embodiments of a enhanced file server using an enhanced file pathname syntax. Further, the enhanced file server may be implemented in software, hardware, firmware, or in some combination to achieve the capabilities described herein.

The computing system 300 may comprise one or more server and/or client computing systems and may span distributed locations. In addition, each block shown may represent one or more such blocks as appropriate to a specific embodiment or may be combined with other blocks. Moreover, the various blocks of the file server 310 may physically reside on one or more machines, physical and/or virtual, which use standard (e.g., TCP/IP) or proprietary interprocess communication mechanisms to communicate with each other.

In the embodiment shown, computing system 300 comprises a computer memory (“memory”) 301, a display 302, one or more Central Processing Units (“CPU”) 303, Input/Output devices 304 (e.g., keyboard, mouse, CRT or LCD display, etc.), other computer-readable media 305, and one or more network connections 306. The file server 310 is shown residing in memory 301. In other embodiments, some portion of the contents, some of, or all of the components of the enhanced file server 310 may be stored on and/or transmitted over the other computer-readable media 305. The components of the enhanced file server 310 preferably execute on one or more CPUs 303 and manage the generation of security based resource recommendations, as described herein. Other code or programs 330 and potentially other data repositories, such as data repository 320, also reside in the memory 301, and preferably execute on one or more CPUs 303. Of note, one or more of the components in FIG. 3 may not be present in any specific implementation. For example, some embodiments embedded in other software may not provide means for user input or display.

In a typical embodiment, the enhanced file server 310 includes one or more file access network protocol logic 311, one or more indexers 312, one or more path analyzers 313, and one or more recommenders 314 as described with reference to FIGS. 1-2. In addition, a data store 315, and a synthesized content store 316 is provided as described with reference to FIG. 1. In at least some embodiments, the recommender is provided external to the file server and is available, potentially, over one or more networks 350, even though the interface to the user appears through the file server 310. Other and/or different modules may be implemented. In addition, the file server may 310 interact via a network 350 with application or client code 355 that, e.g., uses results computed by the path analyzer 313, one or more client computing systems 360, and/or one or more third-party information provider systems 365, such as directory services. Also, of note, the various data stores 315, and/or 316 may be provided external to the file server as well, for example in a knowledge base accessible over one or more networks 350.

In an example embodiment, components/modules of the enhanced file server 310 are implemented using standard programming techniques. However, a range of programming languages known in the art may be employed for implementing such example embodiments, including representative implementations of various programming language paradigms, including but not limited to, object-oriented (e.g., Java, C++, C#, Smalltalk, etc.), functional (e.g., ML, Lisp, Scheme, etc.), procedural (e.g., C, Pascal, Ada, Modula, etc.), scripting (e.g., Perl, Ruby, Python, JavaScript, VBScript, etc.), declarative (e.g., SQL, Prolog, etc.), etc.

The embodiments described above may also use well-known or proprietary synchronous or asynchronous client-server computing techniques. However, the various components may be implemented using more monolithic programming techniques as well, for example, as an executable running on a single CPU computer system, or alternately decomposed using a variety of structuring techniques known in the art, including but not limited to, multiprogramming, multithreading, client-server, or peer-to-peer, running on one or more computer systems each having one or more CPUs. Some embodiments are illustrated as executing concurrently and asynchronously and communicating using message passing techniques. Equivalent synchronous embodiments are also supported by an enhanced file server implementation.

In addition, programming interfaces to the data stored as part of the enhanced file server 310 (e.g., in the data repositories 315 and 316) or the recommendations provided by the recommender 314 can be made available by standard means such as through C, C++, C#, and Java APIs; libraries for accessing files, databases, or other data repositories; through scripting languages such as XML; or through Web servers, FTP servers, or other types of servers providing access to stored data. The data stores 315 and 316 may be implemented as one or more database systems, file systems, or any other method known in the art for storing such information, or any combination of the above, including implementation using distributed computing techniques.

Also the example enhanced file server 310 may be implemented in a distributed environment comprising multiple, even heterogeneous, computer systems and networks. For example, in one embodiment, the indexer 312 and the recommender 314 are all located in physically different computer systems. In another embodiment, various modules of the enhanced file server 310 are hosted each on a separate server machine and may be remotely located from the tables which are stored in the repositories 315-316. Also, one or more of the modules may themselves be distributed, pooled or otherwise grouped, such as for load balancing, reliability or security reasons. Different configurations and locations of programs and data are contemplated for use with techniques of described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, etc.) etc. Other variations are possible. Also, other functionality could be provided by each component/module, or existing functionality could be distributed amongst the components/modules in different ways, yet still achieve the functions of an enhanced file server.

Furthermore, in some embodiments, some or all of the components of the enhanced file server may be implemented or provided in other manners, such as at least partially in firmware and/or hardware, including, but not limited to one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the system components and/or data structures may also be stored (e.g., as executable or other machine readable software instructions or structured data) on a computer-readable medium (e.g., a hard disk; a memory; a network; or a portable media article to be read by an appropriate drive or via an appropriate connection). Some or all of the components and/or data structures may be stored on tangible storage mediums. Some or all of the system components and data structures may also be transmitted in a non-transitory manner via generated data signals (e.g., as part of a carrier wave or other analog or digital propagated signal) on a variety of computer-readable transmission mediums, such as media 305, including wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

From the foregoing it will be appreciated that, although specific embodiments have been described herein for purposes of illustration, various modifications may be made without deviating from the spirit and scope of the invention. For example, the methods and systems for providing in-band search and recommendations as discussed herein are applicable to other architectures other than a Windows or a UNIX/Linux architecture. Also, the methods and systems discussed herein are applicable to differing protocols, communication media (optical, wireless, cable, etc.) and devices (such as wireless handsets, electronic organizers, personal digital assistants, portable email machines, game machines, tablets, pagers, navigation devices such as GPS receivers, etc.).

1. A computer-implemented method in a file server for providing search and/or recommendation functions using standard shared file network protocols, comprising:
receiving file server request including an indication of a file pathname specification;
determining from the indicated file pathname specification whether the received file server request is a request for a search or for a recommendation;
when it is determined that the received file server request is a request for a search or for a recommendation, performing the search or the recommendation and returning results of the performed search or recommendation using the standard shared file network protocols; and
when it is determined that the received file server request is not a request for a search or for a recommendation, returning an indication of a requested file, as indicated by the file pathname specification.

2. The method of claim 1, further comprising:
returning results of the performed search or recommendation using a synthesized file server structure.

3. The method of claim 2 wherein the synthesized file server structure is a synthesized directory, folder, or container.

4. The method of claim 3, further comprising:
storing the synthesized directory as a directory in a file system.

5. The method of claim 1 wherein the determining from the indicated file pathname specification whether the received file server request is a request for a search or for a recommendation is performed by analyzing the indicated file pathname for a key term.

6. The method of claim 5 wherein the key term includes the phrase “search” within a file pathname syntax supported by the file server.

7. The method of claim 5 wherein the key term includes the phrase “recommendation” within a file pathname syntax supported by the file server.

8. The method of claim 5 wherein the indicated file pathname specification uses an escape character mechanism to preserve data that indicates a file pathname that is similar to the key term.

9. The method of claim 5 wherein the indicated file pathname specification uses an escape character mechanism to allow the inclusion of searches for character patterns disallowed by a file pathname syntax supported by the file server.

10. The method of claim 1 wherein when it is determined that the received file server request is a request for a search, performing the search using a portion of the indicated file pathname specification as the search query terms.

11. The method of claim 1 wherein when it is determined that the received file server request is a request for a recommendation, performing the recommendation based upon one or more criteria.

12. The method of claim 11 wherein the one or more criteria is at least one of prior access history of a user from which the file server request was received and/or prior access history of a plurality of other users that are similar to the prior access history of the user.

13. The method of claim 12 wherein similarity is based upon a shared security group profile.

14. The method of claim 11 wherein the one or more criteria includes recency of file access.

15. The method of claim 1 wherein the shared file network protocol is at least one of SMB/CIFS, FTP, WebDAV, and/or NFS.

16. A computer-readable medium containing contents that, when executed, provide search and/or recommendation functions using standard shared file network protocols, by performing a method comprising:
receiving file server request including an indication of a file pathname specification;
determining from the indicated file pathname specification whether the received file server request is a request for a search or for a recommendation;
when it is determined that the received file server request is a request for a search or for a recommendation, performing the search or the recommendation and returning results of the performed search or recommendation using the standard shared file network protocols; and
when it is determined that the received file server request is not a request for a search or for a recommendation, returning an indication of a requested file, as indicated by the file pathname specification.

17. The computer-readable medium of claim 16 wherein the medium is a computer memory and the contents are computer instructions stored in the memory.

18. The computer-readable medium of claim 16 wherein the contents are instructions that when executed cause the computing system to perform the method.

19. A computing system comprising:
a memory;
a data store;
file access network protocol code; and
a path analyzer, stored in the memory, and that is configured, when executed,
receives a file server request including an indication of a file path specification;
determines from the indicated file path whether the received file server request is a request for a search or for a recommendation;
when it is determined that the received file server request is a request for a search or for a recommendation, perform the search or the recommendation and return results of the performed search or recommendation using the file access network protocol code.

20. The computing system of claim 19 wherein the path analyzer is further configured, when executed, to:
when it is determined that the received file server request is not a request for a search or for a recommendation, returning an indication of a requested file, as indicated by the file path specification.

21. The computing system of claim 19, further comprising:
an indexer; and
wherein the path analyzer is further configured, when executed, to invoke the indexer to perform the search or the recommendation.

22. The computing system of claim 19, further comprising:
a recommender; and
wherein, when it is determined that the received file server request is a request for a recommendation, the path analyzer is further configured, when executed, to invoke the recommender to perform the recommendation.

23. The computing system of claim 19, further comprising:
a synthesized content data store; and
wherein, when it is determined that the received file server request is a request for a search or for a recommendation, the path analyzer is further configured, when executed, to perform the search or the recommendation and return results of the performed search or recommendation by synthesizing content in the synthesized content data store to contain the results, and returning the synthesized content using the file access network protocol code.

24. The computing system of claim 19 wherein the file access network protocol code is logic that processes at least one of SMB/CIFS, FTP, WebDAV, and/or NFS.
